(19) United States
(12) Patent Application Publication
(10) Pub. No.: US 2014/0180605 A1
(43) Pub. Date: Jun. 26, 2014

(54) Piston Sensor Data Acquisition System and Method

(71) Applicant: CATERPILLAR INC., Peoria, IL (US)

(72) Inventor: Jay L. Richerson, Elmwood, IL (US)

(73) Assignee: CATERPILLAR INC., Peoria, IL (US)

(21) Appl. No.: 13/724,290

(22) Filed: Dec. 21, 2012

(51) Int. Cl. G01M 15/06; G06F 17/50; G06F 17/00

(52) U.S. Cl. CPC G01M 15/06; G06F 17/00; G06F 17/5086
USPC 702/33; 703/7

(57) ABSTRACT

A piston sensor data acquisition system is provided. The system includes a piston for an internal combustion engine, a data acquisition computer and a data telemetry system. The piston includes a crown and a sensor. The piston crown includes an upper surface defining a bowl region, a side portion and a lower surface. The sensor is at least partially coated by a visualization material, and is disposed at a location within the piston crown. The data acquisition computer includes a processor and a memory to store the sensor location, determined by a visualization process, and sensor data received from the sensor. The data telemetry system is coupled to the sensor and the data acquisition computer, and may be wired or wireless. A modeling computer may be coupled to the data acquisition computer over a network.

### TECHNICAL FIELD

The present disclosure relates to pistons for internal combustion engines. More particularly, the present disclosure relates to a piston sensor data acquisition system and method.

### BACKGROUND

During the operation of an internal combustion engine, it is desirable to acquire temperature data at various locations within one of the pistons during different engine loading conditions. To collect these data, one or more through passages or bores are drilled into the piston from the top surface of the crown to the bottom surface of the crown or the undercrown, or, alternatively, through the sidewall into a cooling gallery or the bottom surface of the crown. Thermocouples are inserted into the through passages or bores, and the space above the thermocouple, as well as the space behind the thermocouple, is filled with heat resistant material to prevent damage to the thermocouple. Alternatively, the space above the thermocouple may be tapped to receive a metal screw.

There are many locations within the piston for which temperature data is desirable, but drilling the through passage or bore for the thermocouple is simply not possible due to various physical constraints. Furthermore, the location of the thermocouple is known only to a certain spatial precision, which may not satisfy the accuracy requirements of computer-based piston and/or engine modeling tools. When accurate thermocouple locations need to be determined, the piston is destructively sectioned after the testing is completed in order to measure the precise location of the thermocouple in relation to the crown, sidewalls and undercrown of the piston. Accordingly, computer-based piston and/or engine modeling can only be accomplished after the precise location of the thermocouples are determined through destructive means, after which further testing of that piston is no longer possible.

It is therefore desirable to be able to accurately and non-destructively locate thermocouples and/or other sensors within a piston at any desired location, with a much higher degree of precision, than has previously been possible, in order to acquire accurate data from such embedded sensors.

### SUMMARY

One aspect of the present disclosure provides a piston sensor data acquisition system. The system includes a piston for an internal combustion engine, a data acquisition computer and a data telemetry system. The piston includes a crown and a sensor. The piston crown includes an upper surface defining a bowl region, a side portion and a lower surface. The sensor is at least partially coated by a visualization material, and is disposed at a location within the piston crown. The data acquisition computer includes a processor and a memory to store the sensor location, determined by a visualization process, and sensor data received from the sensor. The data telemetry system is coupled to the sensor and the data acquisition computer.

A further aspect of the present disclosure provides a method for modeling a piston for an internal combustion engine. The method includes determining a location of an embedded piston sensor, at least partially coated with a visualization material, prior to engine testing, acquiring piston sensor data during engine testing, providing the piston sensor location and the piston sensor data to a model, and updating the model based on the piston sensor location and the piston sensor data.

Another aspect of the present disclosure provides a piston sensor data acquisition system. The system includes a piston for an internal combustion engine, a data acquisition computer, a modeling computer and a network coupled to the data acquisition computer and the modeling computer. The piston includes a piston crown including an upper surface defining a bowl region, a side portion and a lower surface, a temperature sensor, at least partially coated by silver, disposed at a location within the piston crown, and a wireless transmitter, coupled to the sensor, to transmit sensor data. The data acquisition computer includes a wireless receiver to receive the sensor data transmitted from the wireless transmitter, a processor coupled to the wireless receiver, and a memory to store the sensor location, determined by an x-ray imaging process, and the sensor data. The modeling computer includes a memory, and a processor, coupled to the memory, to receive the sensor location and the sensor data from the data acquisition computer, and to model the piston using the sensor location and the sensor data.

### BRIEF DESCRIPTION OF THE DRAWINGS

FIG. 1 presents a cross section of a portion of a piston for an internal combustion engine in accordance with the present disclosure.

FIG. 2 illustrates a cross section of a portion of a piston for an internal combustion engine, depicting various exemplary sensors, in accordance with the present disclosure.

FIG. 3 illustrates a cross section of a portion of a piston for an internal combustion engine, depicting various exemplary sensors, in accordance with the present disclosure.

FIG. 4 depicts a system for acquiring data from an instrumented piston, in accordance with the present disclosure.

FIG. 5 depicts a flowchart for a method for modeling a piston for a combustion engine, in accordance with the present disclosure.

### DETAILED DESCRIPTION

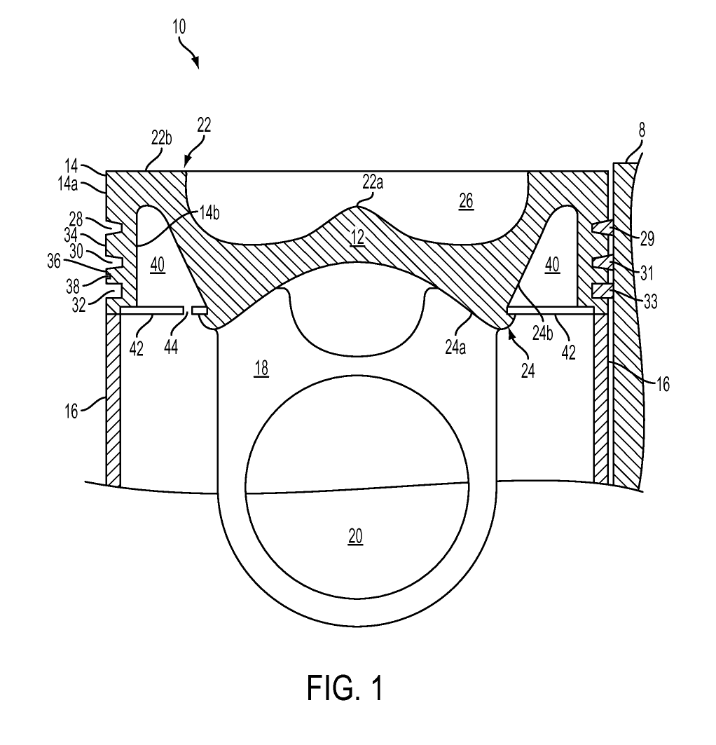

FIG. 1 presents a cross section of a portion of a piston for an internal combustion engine in accordance with the present disclosure.

For reference purposes, a portion of combustion engine cylinder wall 8 is depicted on the right side of FIG. 1. Piston 10 includes a crown 12, a side portion 14 depending from the upper periphery of crown 12, a skirt 16, depending from the side wall 14, and a pin bosses 18 depending from the lower central region of crown 12. Alternatively, pin bosses 18 may be formed within skirt 16. Each pin boss 18 includes a pin bore 20. Crown 12 has an upper surface 22 and a lower surface 24. A combustion bowl region 26, defined by a portion 22a of the upper surface 22, is formed within the crown 12, while the remaining portion 22b of upper surface 22 is generally planar. One portion 24a of the lower surface 24 may be generally curved, while another portion 24b of the lower surface 24 may be generally straight. A cooling gallery may be formed within the crown 12, defined by the inner surface 14b of side wall 14, the lower surface portion 24b and a cooling gallery ring 42. At least one small through passage or bore 44 may be provided in cooling gallery ring 42.

The outer surface 14a of side wall 14 may include one or more ring grooves 28, 30, 32 which may contain one or more piston rings 29, 31, 33, respectively, as well as one or more lands 34, 36 therebetween. An accumulation groove 38 may also be provided in one of the lands, such as land 36, to capture carbon deposits. Additionally, a cooling gallery 40 may be formed within the crown 12, as defined by the inner surface 14b of side wall 14, the lower surface portion 24b of the lower surface 24 and the cooling gallery ring 44.

In one embodiment, piston 10 may be formed by casting, as is known in the art.

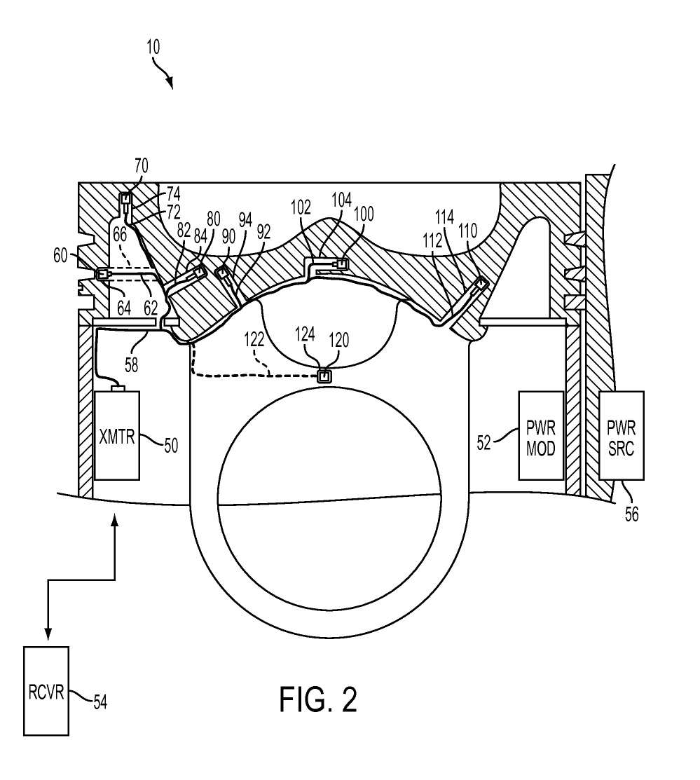

FIG. 2 illustrates a cross section of a portion of a piston for an internal combustion engine, depicting various exemplary sensors, in accordance with the present disclosure.

Piston 10 may be advantageously instrumented with various temperature sensors whose spatial location may be accurately determined using non-destructive means. The number of temperature sensors installed within piston 10 may depend upon the requirements of the piston and/or engine modeling tools, as well as the physical dimensions of piston 10. For example, 5 or less temperature sensors may be used for small pistons, such as, for example, a piston within a small (1 L) displacement diesel engine, while 40 or more temperature sensors may be used for a large piston, such as, for example, a piston within a large (200 L) displacement diesel engine.

While FIG. 2 depicts a wireless telemetry system, a hard-wired system including a sensor wire harness and a mechanical grasshopper-type linkage may also be used. Generally, the wireless telemetry system includes a wireless transmitter 50 electrically connected to a wireless power module 52, a receiver 54 and a power source 56. Wireless transmitter 50 and wireless power module 52 may be mounted to opposing inner surfaces of the skirt 16, while power source 56 may be mounted on an outer surface of the cylinder wall 8, crank case or, generally, on the engine block. Power source 56 inductively couples power to wireless power module 52.

As depicted in FIG. 2, various temperature sensors 60, 70, 80, 90, 100, 110, 120 are located within piston 10, each of which has a pair of wire leads 62, 72, 82, 92, 102, 112, 122 that is connected to wireless transmitter 50 through a cable harness 58. In one embodiment, the sensors are J type thermocouples; other types of temperature sensors may also be used, such as, for example, a thermistor, a resistive temperature detector (RTD), etc., as well as other types of sensors, generally, alone or in combination with temperature sensors, such as, for example, a strain gauge, an accelerometer, a pressure transducer, a proximity probe, etc. In this embodiment, a passage or bore is formed for each temperature sensor during the piston casting process, and each temperature sensor is then installed within a specific passage. The temperature sensor wire leads 62, 72, 82, 92, 102, 112, 122 extend out of each respective passage 64, 74, 84, 94, 104, 114, 124 and are coupled to the cable harness 58. Heat resistant material is provided within each passage to seal the passage and prevent the temperature sensor from overheating.

In one embodiment, the passages 64, 74, 84, 94, 104, 114, 124 may be formed using respective soluble cores that are attached to, and extend from, the mold. The piston mold is formed, which includes the piston crown and the piston skirt. Alternatively, the piston crown may be cast separately from the piston skirt, and subsequently mated. Soluble casting cores are then suspended within the mold to define passages 64, 74, 84, 94, 104, 114, 124. After the piston 10 is cast and the mold removed, the soluble cores are dissolved, leaving the passages 64, 74, 84, 94, 104, 114, 124 within piston 10. Generally linear passages, such as passages 64, 74, 84, 94, 114 may be formed, as well as non-linear passages, such as passage 104 which includes one or more changes in direction, such as a 90° bend, or passages that intersect the cross-sectional plane, such as passage 124, which runs generally perpendicular to the cross-sectional plane depicted in FIG. 2.

Various exemplary temperature sensor locations are illustrated in FIG. 2. While these locations are depicted in the same cross-sectional plane, additional temperature sensors may be mounted within the piston at other locations, generally, as well as other cross-sectional planes. For example, defining the cross-sectional plane depicted in FIG. 2 as the 0° plane, one or more additional temperature sensors may be located in the 30°, 60°, 90°, 120° and 150° cross-sectional planes. Both symmetrical and non-symmetrical distributions are contemplated by the present disclosure, which may be driven by piston and cylinder design considerations, such as the location of intake and exhaust valves, the location of cooling oil impingement points on the undercrown, etc.

Temperature sensor 60 is located within the side wall 14 proximate to ring groove 30. Passage 64 extends horizontally through inner surface 14b to cooling gallery 40, and may be relatively short in length due to the thickness of the side wall 14 at this location. A tube 66 may extend from the inner surface 14b of side wall 14 to the lower surface portion 24b to protect wire leads 62. The end of passage 64, and the head of temperature sensor 60, may be about 1 mm to 5 mm from the inner wall of ring groove 30.

Temperature sensor 70 is located within the upper portion of crown 12 proximate to planar surface 22b. Passage 74 extends vertically through lower surface portion 24b to cooling gallery 40, and may be of moderate length due to the thickness of the crown 12 at this location. The end of passageway 74, and the head of temperature sensor 70, may be about 1 mm to 5 mm from the planar surface 22b.

Temperature sensor 80 is located within the crown 12 proximate to the upper surface portion 22a defining the combustion bowl region 26. Passage 84 extends at a downward angle through lower surface portion 24b to cooling gallery 40, and may be of moderate length due to the thickness of the crown 12 at this location. The end of passage 84, and the head of temperature sensor 80, may be about 1 mm to 5 mm from the upper surface portion 22a.

Temperature sensor 90 is similarly located within the crown 12 proximate to the upper surface portion 22a defining the combustion bowl region 26. Passage 94 extends at a downward angle through the curved lower surface portion 22b, and may be of moderate length due to the thickness of the crown 12 at this location. The end of passage 94, and the head of temperature sensor 90, may be about 1 mm to 5 mm from the upper surface portion 22a.

Temperature sensor 100 is located within the crown 12 proximate to the lower surface portion 24a or the undercrown. Passage 104 extends horizontally and then vertically through the lower surface portion 24a, and may be of moderate length due to the thickness of the crown 12 at this location. The end of passage 104, and the head of temperature sensor 100, may be about 1 mm to 5 mm from the lower surface portion 24a.

Temperature sensor 110 is located within the crown 12 proximate to the lower surface portion 24b defining the cooling gallery 40. Passage 114 extends at a downward angle through lower surface portion 24a, and may be of moderate length due to the thickness of the crown 12 at this location. The end of passage 114, and the head of temperature sensor 110, may be about 1 mm to 5 mm from the lower surface portion 24b.

Temperature sensor 120 is located within one of the pin bosses 18, and is mounted perpendicularly to the cross-sectional plane. Passage 124 extends at through the outer surface of the pin boss 18, and may be of short length due to the thickness of the crown 12 at this location. The end of passage 124, and the head of temperature sensor 120, may be about 1 mm to 5 mm from the opposing surface of the pin boss 18. The wire leads 122 run along the back side of pin boss 18.

While exemplary distances from the head of the sensors to the surfaces of interest are provided above, larger or even smaller distances are also contemplated by the present disclosure.

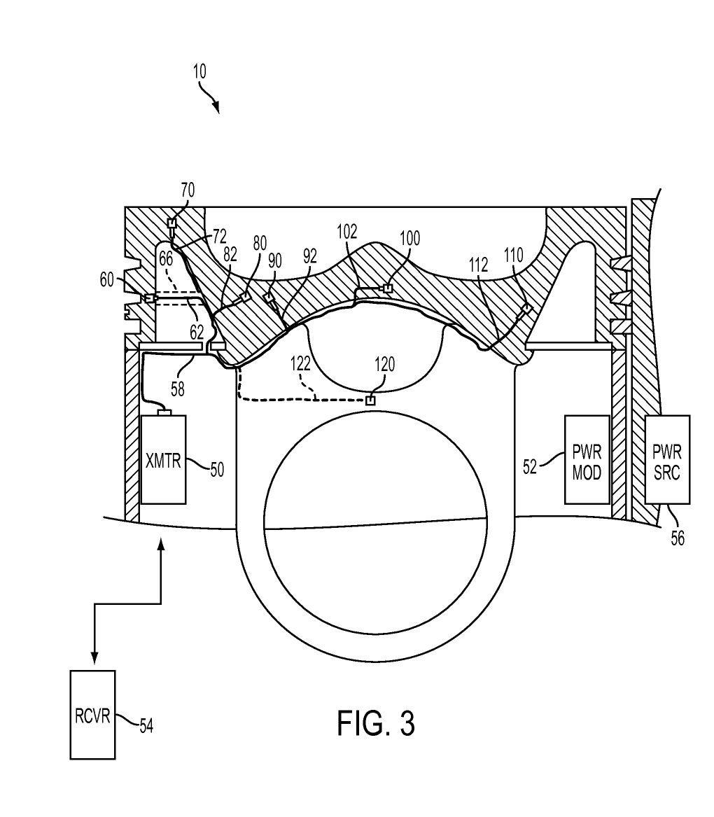

FIG. 3 illustrates a cross section of a portion of a piston for an internal combustion engine, depicting various exemplary sensors, in accordance with the present disclosure.

As depicted in FIG. 3, temperature sensors 60, 70, 80, 90, 100, 110, 120 are located within piston 10, each of which has a pair of wire leads 62, 72, 82, 92, 102, 112, 122 that is connected to wireless transmitter 50 through a cable harness 58. In this embodiment, the temperature sensors are directly cast into piston 10 during the piston casting process. The temperature sensor wire leads 62, 72, 82, 92, 102, 112, 122 extend out of piston 10 at various locations, and are then coupled to the cable harness 58. In order to orient the temperature sensors properly during the casting process, rigid wire leads may be used to extend the temperature sensors from the mold surface into the piston volume. Alternatively, metal inserts, rings, etc. may also be used to suspend the temperature sensors within the mold at their proper locations.

### INDUSTRIAL APPLICABILITY

In order to accurately locate the sensors within piston 10, a portion of each sensor is at least partially coated with a visualizing material, such as silver, and the piston is imaged using a high resolution imaging device, such as, for example, an X-ray imaging device, etc. The location of each sensor is resolved in three dimensions to very high accuracies, such as, for example, from 0.1 to 0.001 mm. For example, for a thermocouple having a pair of conductors coupled at a junction, the junction is at least partially coated with silver. The X-ray image obtained by a CT scanner, for example, allows post-image processing software to calculate the location of the thermocouple in three dimensions relative to a piston-based coordinate system. For example, North Star Imaging, Inc. has developed X-ray imaging systems and services in these areas.

Advantageously, the piston may be imaged prior to installation within the internal combustion engine, so that accurate three dimensional sensor locations, as well as real time sensor data, may be provided to piston and/or engine modeling or performance software during engine operation. These three dimensional sensor location data may be stored within a data acquisition computer, a modeling computer, etc., as discussed below.

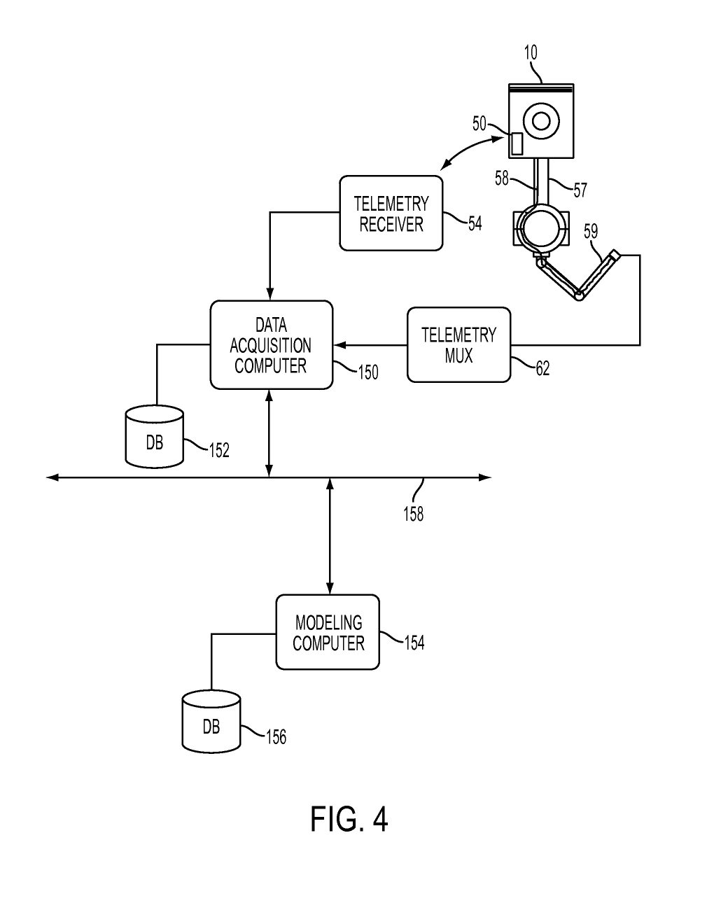

FIG. 4 depicts a system for acquiring data from an instrumented piston, in accordance with the present disclosure.

Piston 10 includes a one or more sensors (not shown for clarity), as described above, that are coupled to the wireless transmitter 50. Analog sensor data may be sampled at a predetermined sampling rate, such as 1 Hz, 5 Hz, etc., and transmitted over a digital wireless link to wireless receiver 54, such as a 2.4 GHz frequency shift key (FSK) link, a Bluetooth wireless connection, etc., as is known in the art. Alternatively, analog sensor data may be transmitted by wireless transmitter 50 over an analog wireless link. In another embodiment, cable harness 58 may extend from the piston 10 to a grasshopper connector 59 attached to a piston connecting rod 57, and then connected to a telemetry multiplexor 62 using one or more additional wire harnesses.

A data acquisition server or computer 150 is coupled to the wireless receiver 54 to receive digital or analog sensor data transmitted from wireless transmitter 50. Digital sensor data may be provided directly to data acquisition computer 150, while analog sensor data may be sampled and digitized by wireless receiver 54 or data acquisition computer 150. In another embodiment, data acquisition computer 150 may be coupled to the telemetry multiplexor 62, which samples the analog sensor data conveyed over cable harness 58 at a predetermined sampling rate, as noted above, and provides the digitized sensor data to data acquisition computer 150.

Sensor data and three dimensional sensor locations may be stored in a non-volatile memory 152, which may include one or more hard disks, optical discs, solid state devices, etc. A relational database may be used to facilitate the storage of sensor data on memory 152, or other known data storage and access techniques may be used. Data acquisition computer 150 may be coupled to network 156, which may be a wired or wireless network, such as a local area network (LAN), a wireless LAN (WLAN), a wide area network (WAN), the Internet, etc.

Modeling server or computer 154 may be coupled to non-volatile memory 156 and network 158, and communicate with data acquisition computer 150 using one or more networking protocols, such as IEEE 802.3, IEEE 802.11, TCP/IP, etc. While FIG. 4 illustrates data acquisition computer 150 and modeling computer 154 as separate servers or computers connected via network 158, alternatively, data acquisition computer 150 and modeling computer 154 may be the same computer or server, a single server with two or more processor boards, a blade server, etc. Data acquisition computer 150 may provide real time piston sensor data and three dimensional sensor locations to modeling computer 154, or, alternatively, data acquisition computer may provide access to a sensor database stored on memory 152. Of course, data acquisition computer 150 may be coupled to other engine sensor telemetry systems to acquire and store other engine sensor data, such as engine speed, NOₓ levels, turbo speed, exhaust temperatures, peak combustion pressure, etc.

Generally, modeling computer 154 hosts an operating system that executes various software tools that process and analyze piston sensor data, provide static and dynamic models of the piston that incorporate the measured sensor data, including, for example, temperatures, stresses, strains, velocities, accelerations, etc., provide one or more models of the combustion engine that incorporate piston, as well as other engine sensor data, etc.

Advantageously, measured temperature sensor data and three dimensional sensor locations may provide a completely defined boundary condition for the piston 10, which allows for a more complete understanding of the danger zone for deposit/structure, for example.

In one embodiment, the combustion process occurring within the cylinder housing piston 10 may be modeled using computational fluid dynamics (CFD), and measured temperature sensor data and three dimensional sensor locations, provided by data acquisition computer 150, may be incorporated in the CFD model to significantly improve the accuracy of the predictions. In another embodiment, modeling of piston ring pack dynamics, using Ricardo's RingPak simulation package for example, improves considerably using measured temperature sensor data and three dimensional sensor locations provided by data acquisition computer 150. In a further embodiment, the performance of the combustion engine may be optimized using sensor data and three dimensional sensor locations, provided by data acquisition computer 150, in combination with other engine sensor data, such as engine speed, NOₓ levels, turbo speed, exhaust temperatures, peak combustion pressure, etc. Other models are also contemplated by the present disclosure, including thermodynamic model, finite element analysis model, etc.

By replacing known destructive piston sensor locating methods, performed at the end of the engine test cycle, with the inventive methods disclosed herein, the development and confirmation of engine operating control parameters using measured piston sensor data may advantageously occur during the entire engine test cycle, rather than after the completion of the engine test cycle, which provides significant cost and schedule savings.

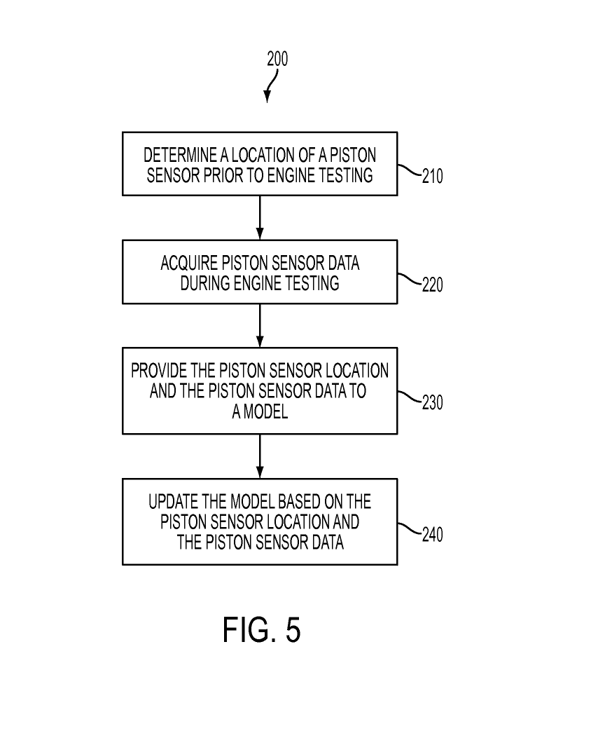

FIG. 5 depicts a flowchart for a method (200) for modeling a piston for a combustion engine, in accordance with the present disclosure.

A location of a piston sensor is determined (210) prior to engine testing. In one embodiment, the piston sensor is at least partially coated with a visualization material, such as silver, and the piston is imaged using a visualization process, such as x-ray imaging, prior to engine testing. The piston sensor location may then be stored within memory 152.

Piston sensor data is acquired (220) during engine testing. In one embodiment, analog piston sensor data is sampled by wireless transmitter 50, and then transmitted to a wireless receiver 54. The piston sensor data may then be stored within memory 152.

The piston sensor location and the piston sensor data is provided (230) to a model. In one embodiment, the piston sensor location and piston sensor data is sent from the data acquisition computer 150 to the modeling computer 154 over network 158.

The model is updated (240) based on the piston sensor location and the piston sensor data. In one embodiment, the piston sensor location and piston sensor data is incorporated into the model, which may be a computational fluid dynamics model of a combustion process, a piston ring pack model, an engine performance model, etc., executed on modeling computer 154.

The many features and advantages of the disclosure are apparent from the detailed specification, and, thus, it is intended by the appended claims to cover all such features and advantages of the disclosure which fall within the true spirit and scope thereof. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A piston sensor data acquisition system, comprising:
a piston for an internal combustion engine, including:
a piston crown including an upper surface defining a bowl region, a side portion and a lower surface, and
a sensor, at least partially coated by a visualization material, disposed at a location within the piston crown;
a data acquisition computer, including:
a processor, and
a memory to store the sensor location, determined by a visualization process, and sensor data received from the sensor; and
a data telemetry system, coupled to the sensor and the data acquisition computer, to provide the sensor data from the sensor to the data acquisition computer.

2. The system according to claim 1, wherein the data telemetry system includes:
a wireless transmitter, attached to the piston and coupled to the sensor, to transmit sensor data; and
a wireless receiver, coupled to the data acquisition computer, to receive the sensor data transmitted from the wireless transmitter.

3. The system according to claim 1, wherein the data telemetry system includes:
a linkage, attached to a connecting rod connected to the piston, including a wire harness coupled to the sensor; and
a telemetry multiplexor, coupled to the data acquisition computer and the wire harness, to receive the sensor data.

4. The system according to claim 1, further comprising:
a network coupled to the data acquisition computer; and
a modeling computer, coupled to the network, including:
a memory, and
a processor, coupled to the memory, to receive the sensor location and the sensor data from the data acquisition computer, and to model the piston using the sensor location and the sensor data.

5. The system according to claim 4, wherein the sensor is a thermocouple, a thermistor, a resistive temperature detector, a strain gauge, an accelerometer, a pressure transducer, or a proximity probe.

6. The system according to claim 5, wherein the modeling computer processor executes a computational fluid dynamics model of a combustion process using the sensor location and the sensor data.

7. The system according to claim 5, wherein the modeling computer processor executes a piston ring pack model using the sensor location and the sensor data.

8. The system according to claim 5, wherein the modeling computer processor executes an engine performance model using the sensor location and the sensor data.

9. The system according to claim 1, wherein the sensor location is about 1 mm to 5 mm from the upper surface of the piston crown.

10. The system according to claim 1, wherein the visualization material is silver and the visualization process produces an x-ray image of the piston.

11. The system according to claim 1, wherein the sensor is a thermocouple having a pair of conductors connected at a junction, wherein the conductors are coupled to the data telemetry system and the junction is at least partially coated by the silver.

12. The system according to claim 11, wherein the sensor is disposed within a passage, formed during a piston casting process, that extends from the sensor location to the lower surface of the piston crown.

13. The system according to claim 11, wherein the sensor is embedded within the piston crown during a piston casting process.

14. A method for modeling a piston for an internal combustion engine, comprising:
determining a location of an embedded piston sensor, at least partially coated with a visualization material, prior to engine testing;
acquiring piston sensor data during engine testing;
providing the piston sensor location and the piston sensor data to a model; and
updating the model based on the piston sensor location and the piston sensor data.

15. The method according to claim 14, further comprising storing the piston sensor location and the piston sensor data in a memory coupled to a data acquisition computer.

16. The method according to claim 15, wherein acquiring piston sensor data includes sampling analog piston sensor data using a wireless transmitter attached to the piston, and transmitting piston sensor data to a wireless receiver coupled to the data acquisition computer.

17. The method according to claim 15, wherein providing the piston sensor location and piston sensor data includes sending the piston sensor location and piston sensor data from the data acquisition computer to a model computer over a network.

18. The method according to claim 15, wherein updating the model includes incorporating the piston sensor location and piston sensor data into the model.

19. The method according to claim 18, wherein the model is a computational fluid dynamics model of a combustion process, a piston ring pack model or an engine performance model.

20. A piston sensor data acquisition system, comprising:
a piston for an internal combustion engine, including:
a piston crown including an upper surface defining a bowl region, a side portion and a lower surface,
a temperature sensor, at least partially coated by silver, disposed at a location within the piston crown, and
a wireless transmitter, coupled to the sensor, to transmit sensor data;
a data acquisition computer, including:
a wireless receiver to receive the sensor data transmitted from the wireless transmitter,
a processor coupled to the wireless receiver, and
a memory to store the sensor location, determined by an x-ray imaging process, and the sensor data;
a modeling computer, including:
a memory, and
a processor, coupled to the memory, to receive the sensor location and the sensor data from the data acquisition computer, and to model the piston using the sensor location and the sensor data; and
a network coupled to the data acquisition computer and the modeling computer.
